(19) United States
(12) Patent Application Publication
(10) Pub. No.: US 2023/0207948 A1
(43) Pub. Date: Jun. 29, 2023

(54) MANUFACTURING SYSTEM FOR BATTERY PACK AND METHOD FOR MANUFACTURING BATTERY PACK

(71) Applicants: PRIMEARTH EV ENERGY CO., LTD, Kosai-shi (JP); TOYOTA JIDOSHA KABUSHIKI KAISHA, Toyota-shi (JP)

(72) Inventors: Kento FUKUDA, Toyohashi-shi (JP); Yuta NEMOTO, Okazaki-shi (JP); Kengo IWAKURA, Tokushima-shi (JP); Kentaro SUZUKI, Kariya-shi (JP)

(73) Assignees: PRIMEARTH EV ENERGY CO., LTD, Kosai-shi (JP); TOYOTA JIDOSHA KABUSHIKI KAISHA, Toyota-shi (JP)

(21) Appl. No.: 18/086,454

(22) Filed: Dec. 21, 2022

(30) Foreign Application Priority Data
Dec. 24, 2021 (JP) 2021-210634

(51) Int. Cl. H01M 50/264; H01M 50/209; H01M 10/04

(52) U.S. Cl. CPC H01M 50/264; H01M 50/209; H01M 10/0404; H01M 10/0481

(57) ABSTRACT

A manufacturing system for a battery pack includes a front-half unit that applies a first pressure to press a stack in a single direction for a certain period of time and a rear-half unit that then causes a restraining member to restrain the stack while applying a second pressure smaller than the first pressure to press the stack in the single direction. The front-half unit includes a front-half pressure application portion that presses the stack and a front-half restriction portion that restricts a position of the stack. The front-half pressure application portion presses the stack with the front-half restriction portion in contact with the stack. The rear-half unit includes a rear-half pressure application portion that presses the stack and a rear-half restriction portion that restricts the position of the stack. The rear-half pressure application portion presses the stack with the front-half or rear-half restriction portion in contact with the stack.

### BACKGROUND

### 1. Field

The present disclosure relates to a manufacturing system for a battery pack and a method for manufacturing a battery pack.

### 2. Description of Related Art

Japanese Laid-Open Patent Publication No. 2012-204172 discloses a manufacturing system for a battery pack. The battery pack is mounted on a vehicle (e.g., battery electric automobile or hybrid electric automobile). The battery pack is used as a power source of the vehicle. The battery pack includes a stack that includes cells stacked in a single direction.

The manufacturing system for the battery pack disclosed in Japanese Laid-Open Patent Publication No. 2012-204172 applies pressure to the stack in the single direction while restricting the position of the stack. This compresses the stack in the single direction while limiting warpage of the stack. The pressed stack is restrained by the restraining member. The battery pack is thus manufactured.

In such a manufacturing system, after the stack is restrained by the restraining member, the application of pressure to the stack is cancelled. When the application of pressure to the stack is cancelled, the pressed stack produces a reaction force. The reaction force may cause the stack to warp. The warpage of the stack adversely affects the quality of the battery pack.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A manufacturing system for a battery pack according to an aspect of the present disclosure is provided. The battery pack includes a stack and a restraining member. The stack includes cells stacked in a single direction. The restraining member restrains the stack. The manufacturing system includes a front-half unit that applies a first pressure to press the stack in the single direction for a certain period of time; and a rear-half unit that causes the restraining member to restrain the stack while applying a second pressure to press the stack in the single direction after the front-half unit presses the stack. The front-half unit includes a front-half pressure application portion that comes into contact with the stack to press the stack and a front-half restriction portion that comes into contact with the stack to restrict a position of the stack. The front-half pressure application portion presses the stack in a state in which the front-half restriction portion is in contact with the stack The rear-half unit includes a rear-half pressure application portion that comes into contact with the stack to press the stack and a rear-half restriction portion that comes into contact with the stack to restrict the position of the stack. The rear-half pressure application portion presses the stack in a state in which the front-half restriction portion or the rear-half restriction portion is in contact with the stack. The second pressure is smaller than the first pressure.

In the above manufacturing system, the stack may include two end plates that sandwich the cells in the single direction. The restraining member may be a case that restrains the stack by accommodating the stack. The two end plates may each include projections extending in the single direction. The front-half pressure application portion may include two front-half pressure application members that respectively come into contact with the two end plates. The two front-half pressure application members may come into contact with distal ends of the projections of the two end plates. The rear-half pressure application portion may include two rear-half pressure application members that respectively come into contact with the two end plates. Each of the two rear-half pressure application members may include insertion portions that are each inserted between adjacent ones of the projections of the two end plates. The insertion portions may come into contact with the end plates so that the rear-half pressure application portion causes the restraining member to accommodate the restraining member while pressing the stack.

The above manufacturing system may include a controller that controls the front-half unit and the rear-half unit. The controller may cause the front-half pressure application portion to apply the first pressure to press the stack for the certain period of time in a state in which the front-half restriction portion restricts the position of the stack, and then cause the front-half pressure application portion to apply the second pressure to press the stack in the state in which the front-half restriction portion restricts the position of the stack. The controller may bring the rear-half restriction portion and the rear-half pressure application portion into contact with the stack in the state in which the front-half restriction portion restricts the position of the stack and in a state in which the front-half pressure application portion applies the second pressure to press the stack. The controller may separate the front-half restriction portion and the front-half pressure application portion from the stack in a state in which the rear-half restriction portion restricts the position of the stack and in a state in which the rear-half pressure application portion applies the second pressure to press the stack.

In the above manufacturing system, the stack may include an upper surface, a lower surface located opposite the upper surface, a first side surface continuous with the upper surface and the lower surface, a second side surface located opposite the first side surface, first restriction pieces located at a corner portion defined by the upper surface and the first side surface, the first restriction pieces being laid out in the single direction, and second restriction pieces located at a corner portion defined by the upper surface and the second side surface, the second restriction pieces being laid out in the single direction. The front-half restriction portion may include a front-half first restriction member that comes into contact with the first restriction pieces, a front-half second restriction member that comes into contact with the second restriction pieces, a front-half third restriction member that comes into contact with the first restriction pieces, a front-half fourth restriction member that comes into contact with the second restriction pieces; an upper surface restriction member that comes into contact with the upper surface, a lower surface restriction member that comes into contact with the lower surface, a first side surface restriction member that comes into contact with the first side surface, and a second side surface restriction member that comes into contact with the second side surface. The front-half first restriction member and the front-half second restriction member respectively come into contact with the first restriction pieces and the second restriction pieces so as to sandwich the stack. The front-half third restriction member comes into contact with the first restriction pieces from above such that the first restriction pieces are pressed against the front-half first restriction member. The front-half fourth restriction member comes into contact with the second restriction pieces from above such that the second restriction pieces are pressed against the front-half second restriction member.

In the above manufacturing system, the rear-half restriction portion may include a rear-half first restriction member that comes into contact with the first restriction pieces, a rear-half second restriction member that comes into contact with the second restriction pieces, a rear-half third restriction member that comes into contact with the first restriction pieces, a rear-half fourth restriction member that comes into contact with the second restriction pieces. The rear-half first restriction member and the rear-half second restriction member may respectively come into contact with the first restriction pieces and the second restriction pieces so as to sandwich the stack. The rear-half third restriction member may come into contact with the first restriction pieces from above such that the first restriction pieces are pressed against the rear-half first restriction member. The rear-half fourth restriction member may come into contact with the second restriction pieces from above such that the second restriction pieces are pressed against the rear-half second restriction member.

In the above manufacturing system, the controller, when bringing the rear-half restriction portion into contact with the stack, may separate the front-half first restriction member, the front-half second restriction member, the front-half third restriction member, and the front-half fourth restriction member from the stack and then bring the rear-half first restriction member, the rear-half second restriction member, the rear-half third restriction member, and the rear-half fourth restriction member into contact with the stack.

A method for manufacturing a battery pack according to another aspect of the present disclosure is provided. The battery pack includes a stack and a restraining member. The stack includes cells stacked in a single direction. The restraining member restrains the stack. The method includes applying a first pressure to press the stack in the single direction for a certain period of time while restricting a position of the stack, applying, after applying the first pressure to press the stack for the certain period of time, a second pressure to press the stack in the single direction while restricting the position of the stack, the second pressure being smaller than the first pressure, and causing the restraining member to restrain the stack to which the second pressure is applied.

Other features and aspects will be apparent from the following detailed description, the drawings, and the claims.

### BRIEF DESCRIPTION OF DRAWINGS

FIG. 1 is a perspective view of a battery pack.

FIG. 2 is a front view showing one of the holders.

FIG. 3 is a front view showing one of the end plates.

FIG. 4 is a side view of the stack.

FIG. 5 is a block diagram showing a manufacturing system for the battery pack.

FIG. 6 is a front view showing the stack held by the front-half unit.

FIG. 7 is a front view showing the stack held by the rear-half unit.

FIG. 8 is a flowchart illustrating the manufacturing routine.

FIG. 9 is a diagram showing that part of the restriction by the front-half restriction portion ends from the state shown in FIG. 6.

FIG. 10 is a diagram showing that the rear-half unit is brought into contact with the stack from the state shown in FIG. 9.

FIG. 11 is a graph showing changes in the pressure applied to the stack.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A manufacturing system 61 for a battery pack 11 will now be described with reference to the drawings. First, the battery pack 11 will be described.

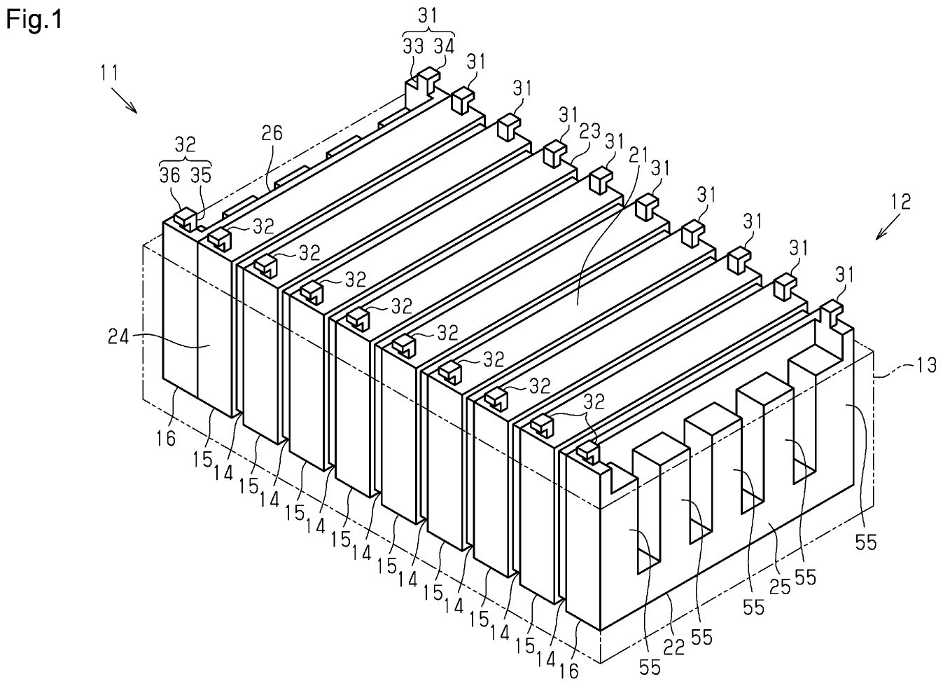

As shown in FIG. 1, the battery pack 11 includes a stack 12 and a restraining member 13. The stack 12 includes cells 14 stacked in a single direction. For example, the cells 14 are stacked in a thickness direction of the cells 14. The restraining member 13 is used to restrain the battery pack 11 while pressing the stack 12 in the single direction. The battery pack 11 is thus manufactured.

In this example, the stack 12 includes the cells 14 and holders 15. The cells 14 and the holders 15 are alternately arranged in the single direction. The stack 12 includes two end plates 16 that sandwich the cells 14 and the holders 15 in the single direction.

The stack 12 has the shape of, for example, a rectangular cuboid. The stack 12 includes an upper surface 21, a lower surface 22, a first side surface 23, a second side surface 24, a front surface 25, and a rear surface 26. The upper surface 21 and the lower surface 22 are opposite to each other. The upper surface 21 and the lower surface 22 are continuous with the first side surface 23, the second side surface 24, the front surface 25, and the rear surface 26. The first side surface 23 and the second side surface 24 are opposite to each other. The first side surface 23 and the second side surface 24 are continuous with the upper surface 21, the lower surface 22, the front surface 25, and the rear surface 26. The front surface 25 and the rear surface 26 are opposite to each other. The front surface 25 and the rear surface 26 are continuous with the upper surface 21, the lower surface 22, the first side surface 23, and the second side surface 24.

The upper surface 21, the lower surface 22, the first side surface 23, and the second side surface 24 are defined by, for example, the cells 14, the holders 15, and the end plates 16. The front surface 25 and the rear surface 26 are oriented in the single direction. The front surface 25 and the rear surface 26 are defined by the two end plates 16, respectively.

The upper surface 21 is exposed from the restraining member 13. The lower surface 22, the first side surface 23, the second side surface 24, the front surface 25, and the rear surface 26 face the restraining member 13. The stack 12 is enclosed by the lower surface 22, the first side surface 23, the second side surface 24, the front surface 25, and the rear surface 26 such that the stack 12 covers them. The stack 12 is thus restrained by the restraining member 13.

The stack 12 includes first restriction pieces 31 and second restriction pieces 32. The first restriction pieces 31 and the second restriction pieces 32 are used to restrict the position of the stack 12. The first restriction pieces 31 and the second restriction pieces 32 are located at corner portions of the stack 12. Specifically, the first restriction pieces 31 are located at a corner portion defined by the upper surface 21 and the first side surface 23. The second restriction pieces 32 are located at a corner portion defined by the upper surface 21 and the second side surface 24. The first restriction pieces 31 are laid out in the single direction at the corner portion of the stack 12. The second restriction pieces 32 are laid out in the single direction at the corner portion of the stack 12. The first restriction pieces 31 and the second restriction pieces 32 extend so as to be exposed from the restraining member 13.

Each first restriction piece 31 includes a first protrusion 33 and a first extension 34. The first protrusion 33 extends upward. The first extension 34 extends from a distal end of the first protrusion 33. The first extension 34 extends, for example, parallel to the upper surface 21. The first restriction piece 31 extends so as to be bent by the first protrusion 33 and the first extension 34. In this example, the first restriction piece 31 extends in an L shape.

Each second restriction piece 32 includes a second protrusion 35 and a second extension 36. The second protrusion 35 extends upward. The second extension 36 extends from a distal end of the second protrusion 35. The second extension 36 extends, for example, parallel to the upper surface 21. The second restriction piece 32 extends so as to be bent by the second protrusion 35 and the second extension 36. In this example, the second restriction piece 32 extends in an L shape. Thus, the first restriction piece 31 and the second restriction piece 32 have the same structure. The first extension 34 and the second extension 36 extend away from each other.

Each cell 14 is a rechargeable battery. The cell 14 is, for example, a lithium-ion rechargeable battery. The cell 14 includes, for example, an electrode body in which a positive electrode, a negative electrode, and a separator are integrated, and a case which accommodates the electrode body. The case contains an electrolyte. The cell 14 includes, for example, a positive electrode terminal and a negative electrode terminal.

Each cell 14 has a rectangular shape as viewed in the single direction. In this example, the cell 14 is slightly smaller than the holder 15 and the end plate 16 as viewed in the single direction. The cell 14 may have the same size as the holder 15 and the end plate 16 as viewed in the single direction.

Each holder 15 holds the corresponding cell 14. The holder 15 is, for example, a spacer. The holder 15 is located between adjacent ones of the cells 14 to promote heat dissipation of the cells 14. The holder 15 is configured to accommodate, for example, part of the cell 14. The holder 15 accommodates the cell 14, for example, such that the positive electrode terminal and the negative electrode terminal are exposed.

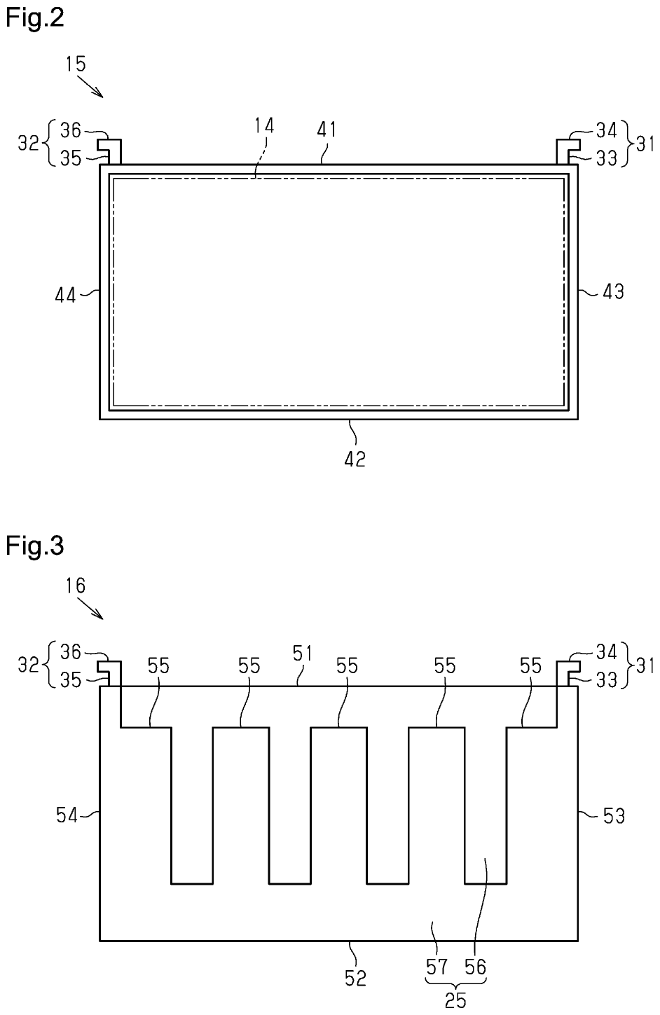

As shown in FIG. 2, the holder 15 has a rectangular shape as viewed in the single direction. The holder 15 includes a holding upper surface 41, a holding lower surface 42, a holding first side surface 43, and a holding second side surface 44. The holding upper surface 41 defines the upper surface 21. The holding lower surface 42 defines the lower surface 22. The holding first side surface 43 defines the first side surface 23. The holding second side surface 44 defines the second side surface 24.

Each holder 15 has the corresponding first restriction piece 31 and the corresponding second restriction piece 32. For example, the first restriction piece 31 and the second restriction piece 32 extend from the holding upper surface 41. The first restriction piece 31 is located at a corner portion defined by the holding upper surface 41 and the holding first side surface 43. The second restriction piece 32 is located at a corner portion defined by the holding upper surface 41 and the holding second side surface 44.

In the holder 15, the first protrusion 33 and the second protrusion 35 extend upward from the holding upper surface 41. In the holder 15, the first extension 34 and the second extension 36 extend, for example, parallel to the holding upper surface 41. In the holder 15, the first extension 34 and the second extension 36 extend away from each other.

As shown in FIG. 3, the end plate 16 has a rectangular shape as viewed in the single direction. The end plate 16 includes a plate upper surface 51, a plate lower surface 52, a plate first side surface 53, and a plate second side surface 54. The plate upper surface 51 defines the upper surface 21. The plate lower surface 52 defines the lower surface 22. The plate first side surface 53 defines the first side surface 23. The plate second side surface 54 defines the second side surface 24.

The end plate 16 has the first restriction piece 31 and the second restriction piece 32. For example, the first restriction piece 31 and the second restriction piece 32 extend from the plate upper surface 51. The first restriction piece 31 is located at a corner portion defined by the plate upper surface 51 and the plate first side surface 53. The second restriction piece 32 is located at a corner portion defined by the plate upper surface 51 and the plate second side surface 54.

In the end plate 16, the first protrusion 33 and the second protrusion 35 extend upward from the plate upper surface 51. In the end plate 16, the first extension 34 and the second extension 36 extend, for example, parallel to the plate upper surface 51. In the end plate 16, the first extension 34 and the second extension 36 extend away from each other.

As shown in FIGS. 1 and 3, the two end plates 16 are located at opposite ends of the stack 12. The two end plates 16 each include projections 55. The projections 55 protrude in a certain direction. The projections 55 are laid out at predetermined intervals in a direction from the first side surface 23 toward the second side surface 24. Thus, a groove is formed between adjacent ones of the projections 55. Each end plate 16 is formed in a comb-like shape by the projections 55.

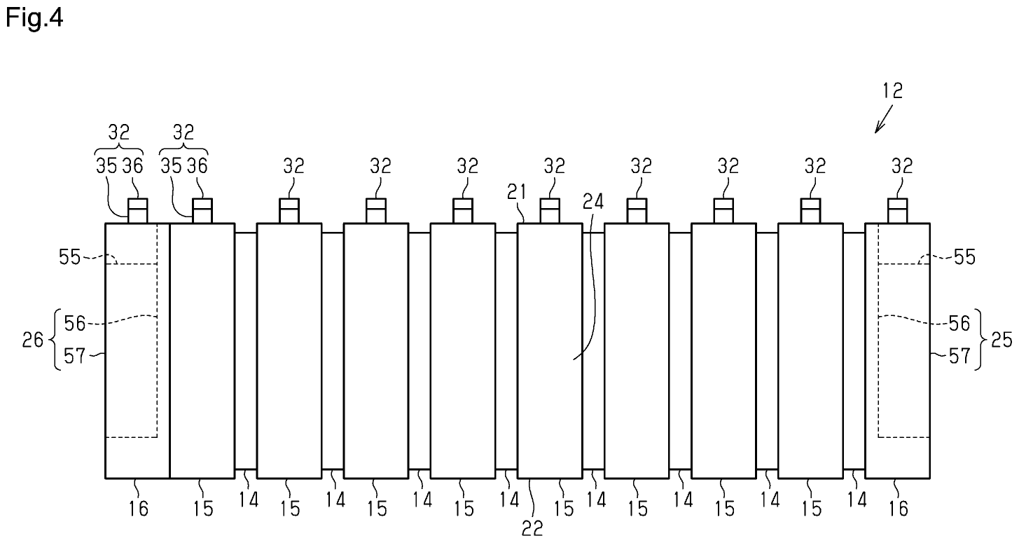

As shown in FIG. 4, the two end plates 16 each include a basal end surface 56 and a distal end surface 57. The basal end surface 56 is a surface on which the projections 55 extend. Thus, basal ends of the projections 55 are located on the basal end surface 56. The distal end surface 57 is defined by distal ends of the projections 55.

The two end plates 16 define the front surface 25 and the rear surface 26, respectively. The front surface 25 is defined by the basal end surface 56 and the distal end surface 57 of one of the two end plates 16. The rear surface 26 is defined by the basal end surface 56 and the distal end surface 57 of the other one of the two end plates 16.

As shown in FIG. 1, the restraining member 13 restrains the stack 12. The restraining member 13 restrains the stack 12 in a state in which the cells 14, the holders 15, and the two end plates 16 are stacked. The restraining member 13 restrains the stack 12 in a state in which the stack 12 is compressed in the single direction.

The restraining member 13 is, for example, a case including members that restrict the opposite ends of the stack 12 in the single direction, which corresponds to the stacking direction. The restraining member 13 is formed through, for example, die casting. The restraining member 13 is configured to accommodate the stack 12. The restraining member 13 restrains the stack 12 by enclosing the stack 12. For example, the restraining member 13 comes into contact with the lower surface 22, the first side surface 23, the second side surface 24, the front surface 25, and the rear surface 26 of the stack 12. The stack 12 is inserted into the restraining member 13 from above to be accommodated in the restraining member 13.

The manufacturing system 61 for the battery pack 11 will now be described. The manufacturing system 61 manufactures the battery pack 11 by restraining the stack 12 with the restraining member 13 while compressing the stack 12.

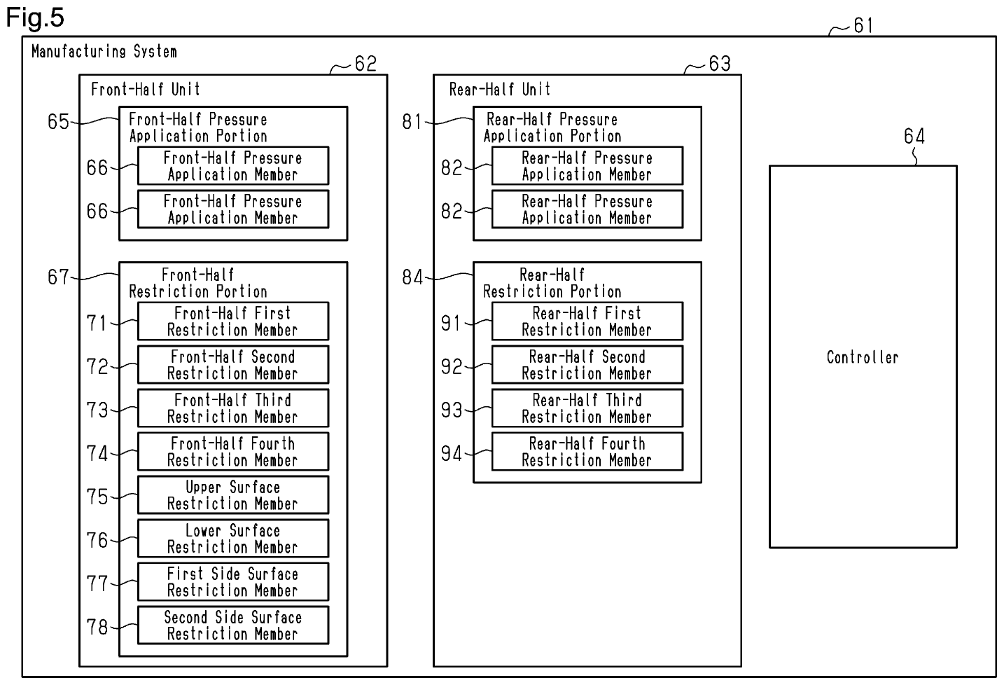

As shown in FIG. 5, the manufacturing system 61 includes a front-half unit 62, a rear-half unit 63, and a controller 64.

The front-half unit 62 is used to press the stack 12 in the single direction. The front-half unit 62 includes a front-half pressure application portion 65. The front-half pressure application portion 65 comes into contact with the stack 12 to press the stack 12 in the single direction. Thus, the stack 12 is compressed in the single direction.

The front-half pressure application portion 65 includes two front-half pressure application members 66. The two front-half pressure application members 66 come into contact with the two end plates 16, respectively. Specifically, the two front-half pressure application members 66 come into contact with the distal end surfaces 57 of the two end plates 16, respectively. The front-half pressure application members 66 come into contact with the distal end surface 57 to press the stack 12. The front-half pressure application members 66 are, for example, flat.

The front-half unit 62 includes a front-half restriction portion 67. The front-half restriction portion 67 comes into contact with the stack 12 to restrict the position of the stack 12. The front-half restriction portion 67 comes into contact with the stack 12 in the single direction.

When the stack 12 is compressed, the stack 12 may warp. This results from deformation of the cells 14, the holders 15, and the end plates 16 caused by the compression of the stack 12. Warping refers to flexing or curving of the stack 12. For example, when the stack 12 is locally compressed, the stack 12 is likely to warp.

The front-half unit 62 uses the front-half pressure application portion 65 to press the stack 12 while restricting the position of the stack 12 using the front-half restriction portion 67. Thus, the stack 12 is evenly compressed. In this manner, the front-half unit 62 compresses the stack 12 while limiting the warpage of the stack 12.

The front-half restriction portion 67 includes a front-half first restriction member 71, a front-half second restriction member 72, a front-half third restriction member 73, a front-half fourth restriction member 74, an upper surface restriction member 75, a lower surface restriction member 76, a first side surface restriction member 77, and a second side surface restriction member 78. Each of the front-half first restriction member 71, the front-half second restriction member 72, the front-half third restriction member 73, the front-half fourth restriction member 74, the upper surface restriction member 75, the lower surface restriction member 76, the first side surface restriction member 77, and the second side surface restriction member 78 is, for example, a plate extending in the single direction.

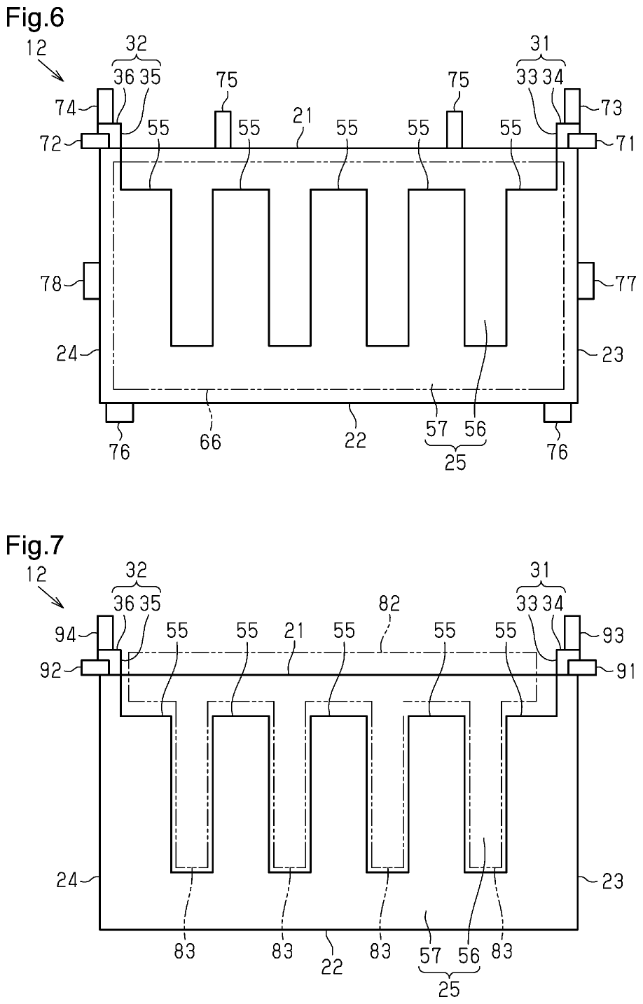

As shown in FIG. 6, the front-half first restriction member 71 comes into contact with the first restriction piece 31 to restrict the position of the stack 12. Specifically, the front-half first restriction member 71 comes into contact with the first protrusion 33 and the first extension 34.

The front-half second restriction member 72 comes into contact with the second restriction piece 32 to restrict the position of the stack 12. Specifically, the front-half second restriction member 72 comes into contact with the second protrusion 35 and the second extension 36. The front-half first restriction member 71 and the front-half second restriction member 72 come into contact with the stack 12 so as to sandwich the stack 12.

The front-half third restriction member 73 comes into contact with the first restriction piece 31 to restrict the position of the stack 12. Specifically, the front-half third restriction member 73 comes into contact with the first extension 34. The front-half third restriction member 73 comes into contact with the first extension 34 from above. The front-half third restriction member 73 comes into contact with the first extension 34 such that the first extension 34 is pressed against the front-half first restriction member 71.

The front-half fourth restriction member 74 comes into contact with the second restriction piece 32 to restrict the position of the stack 12. Specifically, the front-half fourth restriction member 74 comes into contact with the second extension 36. The front-half fourth restriction member 74 comes into contact with the second extension 36 from above. The front-half fourth restriction member 74 comes into contact with the second extension 36 such that the second extension 36 is pressed against the front-half second restriction member 72.

The front-half first restriction member 71, the front-half second restriction member 72, the front-half third restriction member 73, and the front-half fourth restriction member 74 come into contact with the stack 12 so that the stack 12 is positioned relative to the restraining member 13.

The upper surface restriction member 75 comes into contact with the upper surface 21 to restrict the position of the stack 12. For example, the upper surface restriction member 75 comes into contact with the holding upper surface 41 and the plate upper surface 51.

The lower surface restriction member 76 comes into contact with the lower surface 22 to restrict the position of the stack 12. For example, the lower surface restriction member 76 comes into contact with the holding lower surface 42 and the plate lower surface 52. The upper surface restriction member 75 and the lower surface restriction member 76 come into contact with the stack 12 so as to sandwich the stack 12.

The first side surface restriction member 77 comes into contact with the first side surface 23 to restrict the position of the stack 12. For example, the first side surface restriction member 77 comes into contact with the holding first side surface 43 and the plate first side surface 53.

The second side surface restriction member 78 comes into contact with the second side surface 24 to restrict the position of the stack 12. For example, the second side surface restriction member 78 comes into contact with the holding second side surface 44 and the plate second side surface 54. The first side surface restriction member 77 and the second side surface restriction member 78 come into contact with the stack 12 so as to sandwich the stack 12.

Referring to FIG. 5, the rear-half unit 63 presses the stack 12 in the single direction and causes the restraining member 13 to restrain the stack 12. The rear-half unit 63 includes a rear-half pressure application portion 81. The rear-half pressure application portion 81 comes into contact with the stack 12 to press the stack 12 in the single direction. Thus, the stack 12 is compressed in the single direction.

The rear-half pressure application portion 81 includes two rear-half pressure application members 82. The two rear-half pressure application members 82 come into contact with the two end plates 16, respectively. Specifically, the two rear-half pressure application members 82 come into contact with the basal end surfaces 56 of the two end plates 16, respectively.

As shown in FIG. 7, each rear-half pressure application member 82 includes one or more insertion portions 83. Each insertion portion 83 is inserted between adjacent ones of the projections 55. That is, the insertion portion 83 is accommodated in the groove formed between the projections 55. The rear-half pressure application member 82 is formed in a comb-like shape by one or more insertion portions 83.

The rear-half pressure application member 82 is moved so that the insertion portion 83 is inserted between adjacent ones of the projections 55 from above the end plate 16. When the insertion portion 83 is inserted between the projections 55, the rear-half pressure application member 82 comes into contact with the basal end surface 56. The rear-half pressure application member 82 comes into contact with the basal end surface 56 to press the stack 12.

As shown in FIG. 5, the rear-half unit 63 includes a rear-half restriction portion 84. The rear-half restriction portion 84 comes into contact with the stack 12 to restrict the position of the stack 12. The rear-half restriction portion 84 comes into contact with the stack 12 in the single direction.

The rear-half unit 63 presses the stack 12 using the rear-half pressure application portion 81 while restricting the position of the stack 12 using the rear-half restriction portion 84. In the same manner as the front-half unit 62, the rear-half unit 63 compresses the stack 12 while limiting the warpage of the stack 12.

The rear-half restriction portion 84 includes a rear-half first restriction member 91, a rear-half second restriction member 92, a rear-half third restriction member 93, and a rear-half fourth restriction member 94. Each of the rear-half first restriction member 91, the rear-half second restriction member 92, the rear-half third restriction member 93, and the rear-half fourth restriction member 94 is, for example, a plate extending in the single direction.

As shown in FIG. 7, the rear-half first restriction member 91 comes into contact with the first restriction piece 31 to restrict the position of the stack 12. Specifically, the front-half first restriction member 71 comes into contact with the first protrusion 33 and the first extension 34. The rear-half first restriction member 91 has the same structure as the front-half first restriction member 71.

The rear-half second restriction member 92 comes into contact with the second restriction piece 32 to restrict the position of the stack 12. Specifically, the rear-half second restriction member 92 comes into contact with the second protrusion 35 and the second extension 36. The rear-half second restriction member 92 has the same structure as the front-half second restriction member 72. The rear-half first restriction member 91 and the rear-half second restriction member 92 come into contact with the stack 12 so as to sandwich the stack 12.

The rear-half third restriction member 93 comes into contact with the first restriction piece 31 to restrict the position of the stack 12. Specifically, the rear-half third restriction member 93 comes into contact with the first extension 34. The rear-half third restriction member 93 comes into contact with the first extension 34 from above. The rear-half third restriction member 93 comes into contact with the first extension 34 such that the first extension 34 is pressed against the rear-half first restriction member 91. The rear-half third restriction member 93 has the same structure as the front-half third restriction member 73.

The rear-half fourth restriction member 94 comes into contact with the second restriction piece 32 to restrict the position of the stack 12. Specifically, the rear-half fourth restriction member 94 comes into contact with the second extension 36. The rear-half fourth restriction member 94 comes into contact with the second extension 36 from above. The rear-half fourth restriction member 94 comes into contact with the second extension 36 such that the second extension 36 is pressed against the rear-half second restriction member 92. The rear-half fourth restriction member 94 has the same structure as the front-half fourth restriction member 74.

The rear-half first restriction member 91, the rear-half second restriction member 92, the rear-half third restriction member 93, and the rear-half fourth restriction member 94 come into contact with the stack 12 so that the stack 12 is positioned relative to the restraining member 13.

Referring to FIG. 5, the controller 64 controls the manufacturing system 61. The controller 64 controls, for example, the front-half unit 62 and the rear-half unit 63. The controller 64 is connected to the front-half unit 62 and the rear-half unit 63 such that the controller 64 can communicate with the front-half unit 62 and the rear-half unit 63 in a wired or wireless manner.

The controller 64 may be circuitry including: (A) one or more processors that execute various processes according to a computer program; (B) one or more dedicated hardware circuits that execute at least part of the various processes, or (C) a combination thereof. The processor includes a CPU and a memory, such as a RAM and ROM. The memory stores program codes or instructions configured to cause the CPU to execute the processes. The memory, or a computer-readable medium, includes any type of computer-readable media that are accessible by general-purpose computers and dedicated computers.

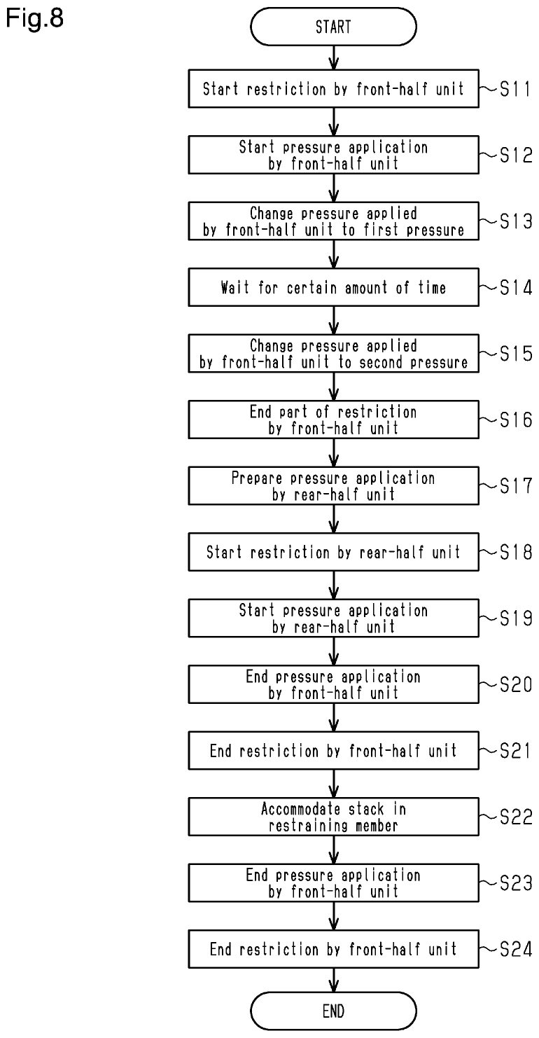

The operation of the manufacturing system 61 will now be described. The manufacturing system 61 manufactures the battery pack 11 by executing a manufacturing routine illustrated in FIG. 8. The manufacturing routine is executed by the controller 64.

As illustrated in FIG. 8, in step S11, the controller 64 starts restriction using the front-half unit 62. The controller 64 brings the front-half restriction portion 67 into contact with the stack 12. This brings the front-half first restriction member 71, the front-half second restriction member 72, the front-half third restriction member 73, the front-half fourth restriction member 74, the upper surface restriction member 75, the lower surface restriction member 76, the first side surface restriction member 77, and the second side surface restriction member 78 into contact with the stack 12. Thus, the front-half unit 62 holds the stack 12.

In step S12, the controller 64 starts the application of pressure performed by the front-half unit 62. The controller 64 brings the front-half pressure application portion 65 into contact with the stack 12. As a result, the front-half pressure application member 66 comes into contact with the end plate 16. The contact of the front-half pressure application member 66 into the end plate 16 causes the front-half pressure application portion 65 to sandwich the stack 12. That is, the front-half pressure application portion 65 applies pressure to the stack 12 in a state in which the front-half restriction portion 67 is in contact with the stack 12.

In step S13, the controller 64 changes the pressure applied by the front-half unit 62 to a first pressure. That is, the controller 64 causes the front-half pressure application portion 65 to apply the first pressure to press the stack 12. The controller 64 increases the pressure applied by the front-half unit 62 until the pressure reaches the first pressure. After the pressure applied by the front-half unit 62 reaches the first pressure, the controller 64 advances the process to step S14.

In step S14, the controller 64 waits for a certain period of time. Thus, the first pressure is applied to the stack 12 by the front-half unit 62 for the certain period of time. As a result, the stack 12 undergoes creep deformation. The creep deformation of the stack 12 limits situations in which the stack 12 returns to its original shape.

In step S15, the controller 64 changes the pressure applied by the front-half unit 62 to a second pressure. That is, the controller 64 causes the front-half pressure application portion 65 to apply the second pressure to press the stack 12. The second pressure is smaller than the first pressure. The second pressure is a minimum pressure for the restraining member 13 to accommodate the stack 12. The controller 64 lowers the pressure applied by the front-half unit 62 from the first pressure to the second pressure. Thus, the controller 64 causes the front-half pressure application portion 65 to apply the first pressure to press the stack 12 for the certain period of time in a state in which the front-half restriction portion 67 restricts the position of the stack 12. Then, the controller 64 causes the front-half pressure application portion 65 to apply the second pressure to press the stack 12 in the state in which the front-half restriction portion 67 restricts the position of the stack 12. After the pressure applied by the front-half unit 62 reaches the second pressure, the controller 64 advances the process to step S16.

In step S16, the controller 64 ends part of the restriction performed by the front-half unit 62. Specifically, the controller 64 ends the restriction using the front-half first restriction member 71, the front-half second restriction member 72, the front-half third restriction member 73, the front-half fourth restriction member 74, and the upper surface restriction member 75. The controller 64 separates the front-half first restriction member 71, the front-half second restriction member 72, the front-half third restriction member 73, the front-half fourth restriction member 74, and the upper surface restriction member 75 from the stack 12. In this step, the lower surface restriction member 76, the first side surface restriction member 77, and the second side surface restriction member 78 remain in contact with the stack 12.

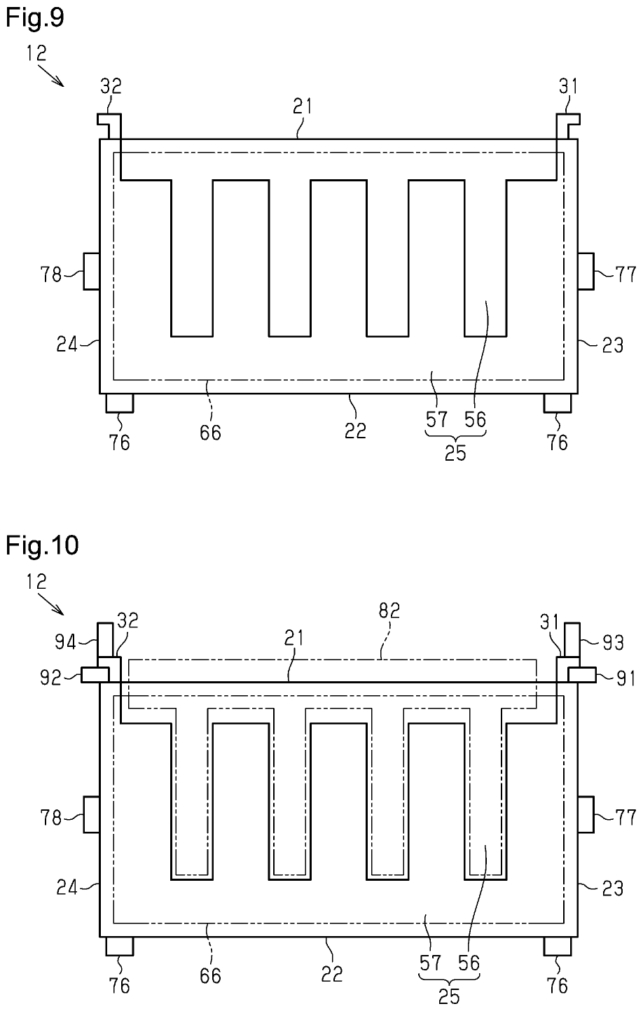

As shown in FIG. 9, when the controller 64 executes step S16, the lower surface restriction member 76, the first side surface restriction member 77, and the second side surface restriction member 78 restrict the position of the stack 12.

As illustrated in FIG. 8, in step S17, the controller 64 prepares the application of pressure performed by the rear-half unit 63. The controller 64 causes the rear-half pressure application portion 81 to approach the stack 12 so that the rear-half unit 63 presses the stack 12. Specifically, the controller 64 causes the rear-half pressure application member 82 to approach the end plate 16 from above so that each insertion portion 83 is inserted between adjacent ones of the projections 55. This brings the rear-half pressure application member 82 into contact with the end plate 16. The contact of the rear-half pressure application member 82 into the end plate 16 causes the rear-half pressure application portion 81 to sandwich the stack 12. In step S17, the front-half first restriction member 71, the front-half second restriction member 72, the front-half third restriction member 73, the front-half fourth restriction member 74, and the upper surface restriction member 75 are not used. This allows the rear-half pressure application member 82 to approach the end plate 16 from above. After each insertion portion 83 is inserted between adjacent ones of the projections 55, the controller 64 advances the process to step S18.

In step S18, the controller 64 starts the application of pressure performed by the rear-half unit 63. The controller 64 brings the rear-half restriction portion 84 into contact with the stack 12. This brings the rear-half first restriction member 91, the rear-half second restriction member 92, the rear-half third restriction member 93, and the rear-half fourth restriction member 94 into contact with the stack 12. Thus, the rear-half unit 63 holds the stack 12. Accordingly, to bring the rear-half restriction portion 84 into contact with the stack 12, the controller 64 separates the front-half first restriction member 71, the front-half second restriction member 72, the front-half third restriction member 73, and the front-half fourth restriction member 74 from the stack 12. Subsequently, the controller 64 brings the rear-half first restriction member 91, the rear-half second restriction member 92, the rear-half third restriction member 93, and the rear-half fourth restriction member 94 into contact with the stack 12.

In step S19, the controller 64 starts the application of pressure performed by the rear-half unit 63. In step S19, the controller 64 causes the rear-half unit 63 to apply the second pressure. The controller 64 increases the pressure applied by the rear-half unit 63 until the pressure reaches the second pressure. After the pressure applied by the rear-half unit 63 reaches the second pressure, the controller 64 advances the process to step S20. In this step, the second pressure is applied to the stack 12 from the front-half pressure application portion 65 and the rear-half pressure application portion 81. The second pressure is limited to a minimum pressure applied according to the dimension of the restraining member 13 in the stacking direction (i.e., single direction). This limits the warpage of the stack 12.

As shown in FIG. 10, when the controller 64 executes step S18, the position of the stack 12 is restricted by the lower surface restriction member 76, the first side surface restriction member 77, the second side surface restriction member 78, the rear-half first restriction member 91, the rear-half second restriction member 92, the rear-half third restriction member 93, and the rear-half fourth restriction member 94.

When the controller 64 executes step S19, the stack 12 is sandwiched by the front-half pressure application portion 65 and by the rear-half pressure application portion 81. In this manner, the controller 64 brings the rear-half restriction portion 84 and the rear-half pressure application portion 81 into contact with the stack 12 in a state in which the front-half restriction portion 67 restricts the position of the stack 12 and in a state in which the front-half pressure application portion 65 applies the second pressure to press the stack 12.

As illustrated in FIG. 8, in step S20, the controller 64 ends the application of pressure performed by the front-half unit 62. The controller 64 separates the front-half pressure application portion 65 from the stack 12. In this step, the rear-half pressure application portion 81 remains in contact with the stack 12. Thus, the rear-half pressure application portion 81 presses the stack 12 in a state in which the front-half restriction portion 67 or the rear-half restriction portion 84 is in contact with the stack 12.

In step S21, the controller 64 ends the restriction performed by the front-half unit 62. Specifically, the controller 64 ends the restriction performed by the lower surface restriction member 76, the first side surface restriction member 77, and the second side surface restriction member 78. The controller 64 separates the lower surface restriction member 76, the first side surface restriction member 77, and the second side surface restriction member 78 from the stack 12. In this step, the rear-half first restriction member 91, the rear-half second restriction member 92, the rear-half third restriction member 93, and the rear-half fourth restriction member 94 remain in contact with the stack 12. Thus, the controller 64 separates the front-half pressure application portion 65 and the front-half restriction portion 67 from the stack 12 in a state in which the rear-half restriction portion 84 restricts the position of the stack 12 and in a state in which the rear-half pressure application portion 81 applies the second pressure to press the stack 12.

In step S22, the controller 64 causes the restraining member 13 to accommodate the stack 12. The controller 64 causes the restraining member to accommodate the stack 12 while pressing the stack 12 using the rear-half unit 63. For example, the controller 64 causes the stack 12 to be inserted into the restraining member 13 from above in a state in which the rear-half pressure application portion 81 and the rear-half restriction portion 84 are in contact with the stack 12. Thus, the stack 12 is restrained by the restraining member 13.

Unlike the front-half restriction portion 67, the rear-half restriction portion 84 does not come into contact with the upper surface 21, the lower surface 22, the first side surface 23, and the second side surface 24. This limits interference of the rear-half restriction portion 84 with the restraining member 13 when the stack 12 is inserted into the restraining member 13. As a result, the stack 12 is accommodated in the restraining member 13 in contact with the rear-half restriction portion 84.

Unlike the front-half pressure application portion 65, the rear-half pressure application portion 81 comes into contact with the basal end surface 56. This limits interference of the rear-half pressure application portion 81 with the restraining member 13 when the stack 12 is inserted into the restraining member 13. As a result, the stack 12 is accommodated in the restraining member 13 in contact with the rear-half pressure application portion 81.

In step S23, the controller 64 ends the application of pressure performed by the rear-half unit 63. In this step, the controller 64 separates the rear-half pressure application portion 81 from the stack 12.

In step S24, the controller 64 ends the restriction performed by the rear-half unit 63. In this step, the controller 64 separates the rear-half restriction portion 84 from the stack 12. Upon completion of the process of step S24, the controller 64 ends the manufacturing routine.

As described above, the method of manufacturing the battery pack 11 includes applying the first pressure to press the stack 12 in the single direction for the certain period of time while restricting the position of the stack 12. Further, the method for manufacturing the battery pack 11 includes applying the first pressure to press the stack 12 for the certain period of time and then applying the second pressure, which is smaller than the first pressure, to the stack 12 in the single direction while restricting the position of the stack 12. Furthermore, the method for manufacturing the battery pack 11 includes causing the restraining member 13 to restrain the stack 12 to which the second pressure is applied.

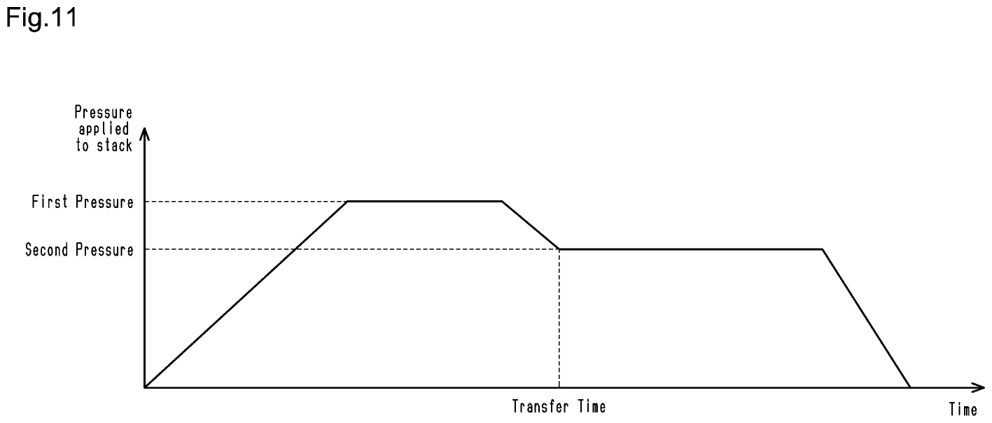

FIG. 11 is a graph showing changes in the pressure applied to the stack 12 during execution of the manufacturing routine.

As shown in FIG. 11, the manufacturing routine includes a transfer time. At the transfer time, the unit that holds the stack 12 changes from the front-half unit 62 to the rear-half unit 63. The transfer time corresponds to the time at which the processes from steps S16 to S21 are executed in the manufacturing routine. Prior to the transfer time, the front-half unit 62 holds the stack 12. At the transfer time, the front-half unit 62 and the rear-half unit 63 hold the stack 12. Subsequent to the transfer time, the rear-half unit 63 holds the stack 12.

In the manufacturing system 61, when the pressure applied to the stack 12 varies, the stack 12 is likely to warp. In this example, at least one of the front-half restriction portion 67 and the rear-half restriction portion 84 is in contact with the stack 12 during the application of pressure to the stack 12. That is, prior to the transfer time, the front-half restriction portion 67 comes into contact with the stack 12. At the transfer time, the front-half restriction portion 67 and the rear-half restriction portion 84 come into contact with the stack 12. Subsequent to the transfer time, the rear-half restriction portion 84 comes into contact with the stack 12. As a result, the stack 12 is less likely to warp.

In the manufacturing system 61, at least one of the front-half pressure application portion 65 and the rear-half pressure application portion 81 presses the stack 12 from when the front-half unit 62 starts the application of pressure to when the stack 12 is accommodated in the restraining member 13. If the application of pressure to the stack 12 is suspended, a reaction force of the stack 12 may cause the stack 12 to warp. In the present example, since pressure is constantly applied to the stack 12, the stack 12 is less likely to warp.

In the manufacturing system 61, after the stack 12 is restrained by the restraining member 13, the application of pressure to the stack 12 is completed. In this case, the stack 12 may warp due to a reaction force of the pressed stack 12. In the present example, the first pressure, which is larger than the second pressure, is applied to the stack 12 for the certain period of time. Thus, the stack 12 undergoes creep deformation. The creep deformation limits situations in which the stack 12 returns to its original shape. As a result, the reaction force of the stack 12 is reduced. Accordingly, the stack 12 is less likely to warp.

The front-half pressure application member 66 is flat and thus easily applies pressure to the stack 12 evenly. The rear-half pressure application member 82 has a comb-like shape and thus applies pressure to the stack 12 less evenly than the front-half pressure application member 66. Accordingly, the application of the first pressure to the stack 12 performed by the front-half pressure application portion 65 is more preferred than the application of the first pressure to the stack 12 performed by the rear-half pressure application portion 81. The front-half pressure application portion 65 allows the stack 12 to properly undergo creep deformation.

The advantages of the above embodiment will now be described.

(1) The manufacturing system 61 includes front-half unit 62, which applies the first pressure to press the stack 12 in the single direction during the certain period of time. The manufacturing system 61 includes the rear-half unit 63. After the front-half unit 62 presses the stack 12, the rear-half unit 63 causes the restraining member 13 to restrain the stack 12 while applying the second pressure to press the stack 12 in the single direction. The second pressure is smaller than the first pressure.

In this configuration, the front-half unit 62 applies the first pressure, which is larger than the second pressure, to the stack 12 for the certain period of time. This causes the stack 12 to undergo creep deformation. The creep deformation of the stack 12 reduces the reaction force of the stack 12. Thus, after the stack 12 is restrained by the restraining member 13, the stack 12 is less likely to warp.

(2) The front-half pressure application portion 65 includes the two front-half pressure application members 66, which respectively come into contact with the two end plates 16. The two front-half pressure application members 66 come into contact with the distal ends of the projections 55 of the two end plates 16. The rear-half pressure application portion 81 includes the two rear-half pressure application members 82, which respectively come into contact with the two end plates 16. The two rear-half pressure application members 82 include the insertion portions 83, each of which is inserted between adjacent ones of the projections 55 of the two end plates 16. The insertion portions 83 come into contact with the end plates 16 so that the rear-half pressure application portion 81 causes the restraining member 13 to accommodate the restraining member 13 while pressing the stack 12.

When the front-half pressure application portion 65 is brought into contact with the distal ends of the projections 55 to press the stack 12, it is difficult for the restraining member 13 to accommodate the stack 12 while pressing the stack 12 by the front-half pressure application portion 65. This is because the front-half pressure application members 66 easily interfere with the restraining member 13. In the above configuration, the insertion portions 83 each inserted between adjacent ones of the projections 55 cause the rear-half pressure application portion 81 to press the stack 12. This limits the interference of the rear-half pressure application members 82 with the restraining member 13. This allows the stack 12 to be easily accommodated in the restraining member 13 while pressing the stack 12 by the rear-half pressure application portion 81.

(3) The controller 64 causes the front-half pressure application portion 65 to apply the first pressure to press the stack 12 for the certain period of time in the state in which the front-half restriction portion 67 restricts the position of the stack 12, and then causes the front-half pressure application portion 65 to apply the second pressure to press the stack 12 in the state in which the front-half restriction portion 67 restricts the position of the stack 12. Further, the controller 64 brings the rear-half restriction portion 84 and the rear-half pressure application portion 81 into contact with the stack 12 in the state in which the front-half restriction portion 67 restricts the position of the stack 12 and in the state in which the front-half pressure application portion 65 applies the second pressure to press the stack 12. Furthermore, the controller 64 separates the front-half pressure application portion 65 and the front-half restriction portion 67 from the stack 12 in the state in which the rear-half restriction portion 84 restricts the position of the stack 12 and in the state in which the rear-half pressure application portion 81 applies the second pressure to press the stack 12.

In this configuration, the stack 12 is pressed in a state in which at least one of the front-half restriction portion 67 and the rear-half restriction portion 84 is in contact with the stack 12. As a result, the stack 12 is less likely to warp.

(4) The front-half restriction portion 67 includes the front-half first restriction member 71, which comes into contact with the first restriction pieces 31, the front-half second restriction member 72, which comes into contact with the second restriction pieces 32, the front-half third restriction member 73, which comes into contact with the first restriction pieces 31, and the front-half fourth restriction member 74, which comes into contact with the second restriction pieces 32. The front-half restriction portion 67 includes the upper surface restriction member 75, which comes into contact with the upper surface 21, the lower surface restriction member 76, which comes into contact with the lower surface 22, the first side surface restriction member 77, which comes into contact with the first side surface 23, and the second side surface restriction member 78, which comes into contact with the second side surface 24. The front-half first restriction member 71 and the front-half second restriction member 72 come into contact with the first restriction pieces 31 and the second restriction pieces 32 so as to sandwich the stack 12. The front-half third restriction member 73 comes into contact with the first restriction pieces 31 from above such that the first restriction pieces 31 are pressed against the front-half first restriction member 71. The front-half fourth restriction member 74 comes into contact with the second restriction pieces 32 from above such that the second restriction pieces 32 are pressed against the front-half second restriction member 72.

In this configuration, the front-half restriction portion 67 comes into contact with the upper surface 21, the lower surface 22, the first side surface 23, the second side surface 24, the first restriction pieces 31, and the second restriction pieces 32. As a result, the stack 12 is less likely to warp.

(5) The rear-half restriction portion 84 includes the rear-half first restriction member 91, which comes into contact with the first restriction pieces 31, the rear-half second restriction member 92, which comes into contact with the second restriction pieces 32, the rear-half third restriction member 93, which comes into contact with the first restriction pieces 31, and the rear-half fourth restriction member 94, which comes into contact with the second restriction pieces 32. The rear-half first restriction member 91 and the rear-half second restriction member 92 respectively come into contact with the first restriction pieces 31 and the second restriction pieces 32 so as to sandwich the stack 12. The rear-half third restriction member 93 comes into contact with the first restriction pieces 31 from above such that the first restriction pieces 31 are pressed against the rear-half first restriction member 91. The rear-half fourth restriction member 94 comes into contact with the second restriction pieces 32 from above such that the second restriction pieces 32 are pressed against the rear-half second restriction member 92.

When the front-half restriction portion 67 is brought into contact with the upper surface 21, the lower surface 22, the first side surface 23, the second side surface 24, the first restriction pieces 31, and the second restriction pieces 32 to restrict the position of the second restriction piece 32, it is difficult to accommodate the stack 12 in the restraining member 13 while restricting the position of the stack 12. This is because the front-half restriction portion 67 easily interferes with the restraining member 13. In the above configuration, the rear-half unit 63 restricts the position of the second restriction piece 32 by bringing the rear-half restriction portion 84 into contact with the first restriction pieces 31 and the second restriction pieces 32. This allows the stack 12 to be easily accommodated in the restraining member 13 while restricting the position of the stack 12.

(6) To bring the rear-half restriction portion 84 into contact with the stack 12, the controller 64 separates the front-half first restriction member 71, the front-half second restriction member 72, the front-half third restriction member 73, and the front-half fourth restriction member 74 from the stack 12. Subsequently, the controller 64 brings the rear-half first restriction member 91, the rear-half second restriction member 92, the rear-half third restriction member 93, and the rear-half fourth restriction member 94 into contact with the stack 12.

In this configuration, from when the front-half first restriction member 71, the front-half second restriction member 72, the front-half third restriction member 73, and the front-half fourth restriction member 74 are separated from the stack 12 to when the rear-half first restriction member 91, the rear-half second restriction member 92, the rear-half third restriction member 93, and the rear-half fourth restriction member 94 come into contact with the stack 12, the position of the stack 12 is restricted by restriction members of the front-half restriction portion 67 other than the front-half first restriction member 71, the front-half second restriction member 72, the front-half third restriction member 73, and the front-half fourth restriction member 74. In this example, the lower surface restriction member 76, the first side surface restriction member 77, and the second side surface restriction member 78 remain in contact with the stack 12. As a result, the stack 12 is less likely to warp.

The present embodiment can be modified as follows. The present embodiment and the following modifications can be combined as long as the combined modifications remain technically consistent with each other.

The restraining member 13 does not have to be attached to the stack 12 using the rear-half unit 63. Instead, for example, the restraining member 13 may be manually attached to the stack 12 pressed by the rear-half unit 63. Alternatively, for example, another unit may be used to attach the restraining member 13 to the stack 12 pressed by the rear-half unit 63.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A manufacturing system for a battery pack, the battery pack including a stack and a restraining member, the stack including cells stacked in a single direction, the restraining member restraining the stack, the manufacturing system comprising:
a front-half unit that applies a first pressure to press the stack in the single direction for a certain period of time; and
a rear-half unit that causes the restraining member to restrain the stack while applying a second pressure to press the stack in the single direction after the front-half unit presses the stack, wherein
the front-half unit includes:
a front-half pressure application portion that comes into contact with the stack to press the stack; and
a front-half restriction portion that comes into contact with the stack to restrict a position of the stack,
the front-half pressure application portion presses the stack in a state in which the front-half restriction portion is in contact with the stack,
the rear-half unit includes:
a rear-half pressure application portion that comes into contact with the stack to press the stack; and
a rear-half restriction portion that comes into contact with the stack to restrict the position of the stack,
the rear-half pressure application portion presses the stack in a state in which the front-half restriction portion or the rear-half restriction portion is in contact with the stack, and
the second pressure is smaller than the first pressure.

2. The manufacturing system according to claim 1, wherein
the stack includes two end plates that sandwich the cells in the single direction,
the restraining member is a case that restrains the stack by accommodating the stack,
the two end plates each include projections extending in the single direction,
the front-half pressure application portion includes two front-half pressure application members that respectively come into contact with the two end plates,
the two front-half pressure application members come into contact with distal ends of the projections of the two end plates,
the rear-half pressure application portion includes two rear-half pressure application members that respectively come into contact with the two end plates,
each of the two rear-half pressure application members includes insertion portions that are each inserted between adjacent ones of the projections of the two end plates, and
the insertion portions come into contact with the end plates so that the rear-half pressure application portion causes the restraining member to accommodate the restraining member while pressing the stack.

3. The manufacturing system according to claim 2, comprising a controller that controls the front-half unit and the rear-half unit, wherein
the controller:
causes the front-half pressure application portion to apply the first pressure to press the stack for the certain period of time in a state in which the front-half restriction portion restricts the position of the stack, and then causes the front-half pressure application portion to apply the second pressure to press the stack in the state in which the front-half restriction portion restricts the position of the stack;
brings the rear-half restriction portion and the rear-half pressure application portion into contact with the stack in the state in which the front-half restriction portion restricts the position of the stack and in a state in which the front-half pressure application portion applies the second pressure to press the stack; and
separates the front-half restriction portion and the front-half pressure application portion from the stack in a state in which the rear-half restriction portion restricts the position of the stack and in a state in which the rear-half pressure application portion applies the second pressure to press the stack.

4. The manufacturing system according to claim 3, wherein
the stack includes:
an upper surface;
a lower surface located opposite the upper surface;
a first side surface continuous with the upper surface and the lower surface;
a second side surface located opposite the first side surface;
first restriction pieces located at a corner portion defined by the upper surface and the first side surface, the first restriction pieces being laid out in the single direction; and
second restriction pieces located at a corner portion defined by the upper surface and the second side surface, the second restriction pieces being laid out in the single direction,
the front-half restriction portion includes:
a front-half first restriction member that comes into contact with the first restriction pieces;
a front-half second restriction member that comes into contact with the second restriction pieces;
a front-half third restriction member that comes into contact with the first restriction pieces;
a front-half fourth restriction member that comes into contact with the second restriction pieces;
an upper surface restriction member that comes into contact with the upper surface;
a lower surface restriction member that comes into contact with the lower surface;
a first side surface restriction member that comes into contact with the first side surface; and
a second side surface restriction member that comes into contact with the second side surface,
the front-half first restriction member and the front-half second restriction member respectively come into contact with the first restriction pieces and the second restriction pieces so as to sandwich the stack,
the front-half third restriction member comes into contact with the first restriction pieces from above such that the first restriction pieces are pressed against the front-half first restriction member, and
the front-half fourth restriction member comes into contact with the second restriction pieces from above such that the second restriction pieces are pressed against the front-half second restriction member.

5. The manufacturing system according to claim 4, wherein
the rear-half restriction portion includes:
a rear-half first restriction member that comes into contact with the first restriction pieces;
a rear-half second restriction member that comes into contact with the second restriction pieces;
a rear-half third restriction member that comes into contact with the first restriction pieces;
a rear-half fourth restriction member that comes into contact with the second restriction pieces,
the rear-half first restriction member and the rear-half second restriction member respectively come into contact with the first restriction pieces and the second restriction pieces so as to sandwich the stack,
the rear-half third restriction member comes into contact with the first restriction pieces from above such that the first restriction pieces are pressed against the rear-half first restriction member, and
the rear-half fourth restriction member comes into contact with the second restriction pieces from above such that the second restriction pieces are pressed against the rear-half second restriction member.

6. The manufacturing system according to claim 5, wherein the controller, when bringing the rear-half restriction portion into contact with the stack, separates the front-half first restriction member, the front-half second restriction member, the front-half third restriction member, and the front-half fourth restriction member from the stack and then brings the rear-half first restriction member, the rear-half second restriction member, the rear-half third restriction member, and the rear-half fourth restriction member into contact with the stack.

7. A method for manufacturing a battery pack, the battery pack including a stack and a restraining member, the stack including cells stacked in a single direction, the restraining member restraining the stack, the method comprising:
applying a first pressure to press the stack in the single direction for a certain period of time while restricting a position of the stack;
applying, after applying the first pressure to press the stack for the certain period of time, a second pressure to press the stack in the single direction while restricting the position of the stack, wherein the second pressure is smaller than the first pressure; and
causing the restraining member to restrain the stack to which the second pressure is applied.
